(19) United States
(12) Patent Application Publication
(10) Pub. No.: US 2004/0150718 A1
(43) Pub. Date: Aug. 5, 2004

(54) Method for the real-time monitoring and transmission of a visual domestic safeguard system

(75) Inventors: Jian Zhang, Hangzhou (CN); Huiming Tang, Hangzhou (CN); Caoming Han, Hangzhou (CN); Wenjie Cui, Hangzhou (CN)

Correspondence Address: CARSTENS YEE & CAHOON, LLP, P O BOX 802334, DALLAS, TX, 75380

(73) Assignee: Jian Zhang, Hangzhou (CN)

(21) Appl. No.: 10/438,079

(22) Filed: May 14, 2003

(30) Foreign Application Priority Data
Jan. 30, 2003 (CN) 03103294.X

(51) Int. Cl. H04N 7/18

(52) U.S. Cl. 348/154; 340/539.1

(57) ABSTRACT

The invention relates to a visual domestic safeguard system and the method for real-time monitoring and transmission. The object of the invention is that the said system is a host-slave system interconnected in wireless communication mode, which performs real-time detection on mobile objects and records them automatically. The visual domestic safeguard system includes a host M and several slaves Z, slave Z is mainly used to obtain video signals while the principal function of host M is to transmit signals to a server through communication networks. In the slave, digital video signals are processed with static/mobile image coding algorithm, encryption algorithm and video mobile object detection algorithm, and later transferred to host M after image compression; the received compressed video and audio signals are displayed directly or stored after decryptions decompression and video coding process, or sent to the server of the domestic safeguard system, and later transmitted to MMS mobile phones e-mailbox or hand-held devices. The invention could performs real-time image monitoring and transmission on several sites.

### FIELD OF THE INVENTION

The present invention relates to a visual domestic safeguard system as well as the method for real-time monitoring and transmission. The said system has a capability of real-time image recording over several locations, automatically recording digital images over abnormal scene and giving an alarm, which may be transmitted betimes to a MMS mobile phones e-mailbox or hand-held devices.

### BACKGROUND OF THE INVENTION

Boolean signal annunciators, such as infrared sensors and microwave probes, are now commonly used in safeguard systems of most domestic residential zones. Once something wrong happened, an alarm would be given either by automatic dial-up or in a manual manner. When security guards or policemen get the alarm, they must reach the alarm points without delay. It would be very difficult for them if they were not familiar with the field and would bring up some disadvantages to the proper settlement of the accidents. It is mostly urgent for them to obtain video and audio field information directly as a reference to properly deal with such accidents betimes as well when they receive an alarm. By now, for long distance image transmission, it is usually transmitted though optical cables or by microwave. Due to the drawback of restriction by terrain and cable network, also too expensive to afford, this solution is difficult to be popularized.

### BRIEF DESCRIPTION OF THE INVENTON

The technical problem to be solved in this invention is that: the visual domestic safeguard system consists of one host M and several slaves Z. Slave Z is mainly used to obtain video signals while the host's principal task is to send these signals to a server through communication networks, wherein:

Slave Z includes video acquisition circuits slave central processing circuits, slave wireless communication interface circuits duplex speaker circuit and control switches. The output of the video acquisition circuit is connected with the input of the slave central processing circuit, which is also connected with the slave wireless communication interface circuit; the duplex speaker circuit is connected with the slave central processing circuit, and control switches are switched in the slave central processing circuit. Mobility detecting algorithm may be implemented in the slave central processing circuit with software.

Host M consists of host wireless communication interface circuit(HWCIC), host central processing circuit(HCPC), communication interface circuit(CIC), display output circuit(DOC), display device, memory circuit and hard disk interface circuit(HDIC). Host wireless communication interface circuit is connected with the host central processing circuit while the output of the latter is connected with the input of display output circuit, whose output again is connected with display devices; host central processing circuit can decode and decrypt the compressed video signals received by HWCIC and then display them directly on the display device through display output circuit module. Host central processing circuit has a communication interface through which it establish a connection with the communication interface circuit; there are also memory circuit and hard disk interface circuit, both are connected with the host central processing circuit.

Slave Z and host M may establish a wireless interconnection in two ways: one is analog mode and the other is digital mode.

While in an analog mode, analog signals obtained by the recorder are transmitted to host M through wireless communication interface;

As for digital mode, slave Z converts analog video signals to digital signals, which are transmitted to host M through the wireless communication interface after compression and encryption.

The said slave central processing circuit includes slave memory, slave primary processor chip and slave Read Only Memory

The said host central processing circuit includes host Read Only Memory, host primary processor chip and host memory.

The communication interface circuit of the host is employed to connect with a server. The communication interface circuit may be a MODEM interface circuit or a network interface circuit, as well as a mobile data communication interface circuit. The interface of the communication interface circuit may be a MODEM circuit of PSTN, GPRS or CDMA.

The method for the real-time monitoring and transmission of visual domestic safeguard systems in this invention is that: the host-slave system, in which host M and slave Z are interconnected in wireless communication mode, is divided into step I and step II implemented by slave Z and host M respectively.

Step I, which is implemented by slave Z, includes:

1) The video acquisition chip in the slave converts the obtained analog signals to digital video signals, which are transferred to the primary processor chip of the slave central processing circuit; the primary processor chip then processes the digital video signals with static/mobile image coding algorithm, encryption algorithm and video mobile object detection algorithm;

2) The process with video mobile object detection algorithm is that detecting mobile objects from images according to the difference degree between currently input image and that recorded previously;

3) Once receive object mobile detection signals and Boolean variable signals, the primary processor chip of the slave triggers the slave central processing circuit to perform image compression and transmit the compressed video and audio data to host M through the slave wireless communication interface circuit.

Step II, which is implemented by host M, includes:

1) The host wireless communication interface circuit stores the received compressed video and audio data in the memory circuit;

2) The primary processor chip of the central processing circuit in host M processes the received video and audio data with static/mobile image decoding algorithm; the received compressed video and audio signals are displayed directly on the display device though display output circuit after decryptions decompression and video coding process; they can also be saved in the memory circuit or stored in hard disks through hard disk interface circuit. These compressed video and audio data can be read from hard disks through hard disk interface circuit or from memory circuit;

3) The communication interface circuit is connected with the host central processing circuit, which transmits the received compressed video signals to the communication interface circuit; the communication interface circuit has a communication interface through which signals are sent to the server of a domestic safeguard system, and later transmitted to MMS mobile phones e-mailbox or hand-held devices.

The advantages of this invention are as following: the safeguard system performs real-time detection on mobile objects and records them automatically. The slaves may be placed in several rooms or any place needed monitoring. No extra cable is needed. When house owners are out, any abnormity can be automatically recorded into digital images, and messages are sent to MMS mobile phones, e-mailbox or hand-held devices immediately so that the owners and guards can have a well know of the house safety at anytime. This invention is more flexible and practical.

### BRIEF DESCRIPTION OF THE APPENDED DRAWINGS

FIG. 1 is a structure block diagram of the slave of this invention.

FIG. 2 is a structure block diagram of the host of this invention.

FIG. 3 is a circuit schematic diagram of the slave of this invention.

FIG. 4 is a circuit schematic diagram of the host of this invention.

### DETAILED DESCRIPTION OF THE INVENTION

The present embodiment of a visual domestic safeguard system is a wireless interconnected host-slave system with one host M and several slaves Z. Slave Z is mainly used to obtain video signals while host M serves principally to transmit signals to the server through communication networks. Two modes are available for the wireless interconnection between the host and slaves, namely analog and digital mode. For analog mode, analog signals obtained by the recorder are transferred to the host via the wireless communication interface; for digital mode, analog video signals are firstly converted to digital signals, which are relayed to the host through the wireless communication interface after compression and encryption process.

Both internal mode and external mode are available for the slave video acquisition circuit. This embodiment is described with only internal mode.

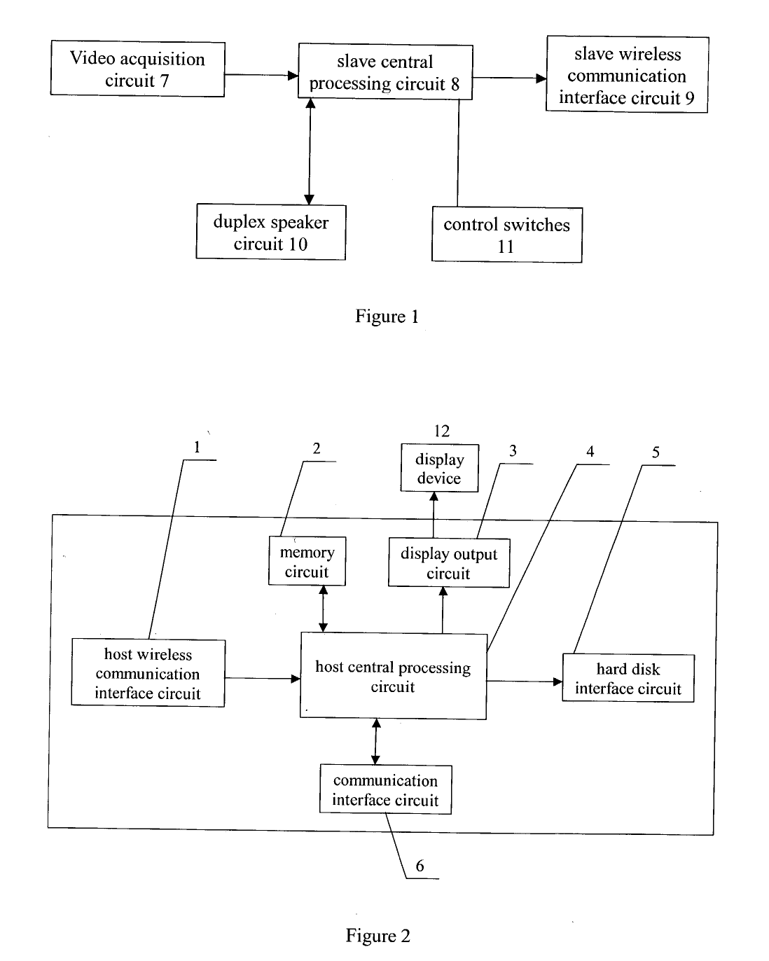

Referring to FIG. 1, slave Z consists of video acquisition circuit 7, slave central processing circuit 8, slave wireless communication interface circuit 9, duplex speaker circuit 10 and control switches 11. Slave wireless communication interface circuit 9 has an internal antenna.

The output of video acquisition circuit 7 is connected with the input of slave central processing circuit 8. Slave central processing circuit 8 is also connected with slave wireless communication interface circuit 9 and slave duplex speaker circuit 10. Control switches 11 are connected in slave central processing circuit 8. Mobile detecting algorithm is implemented in the slave central processing circuit 8 with software.

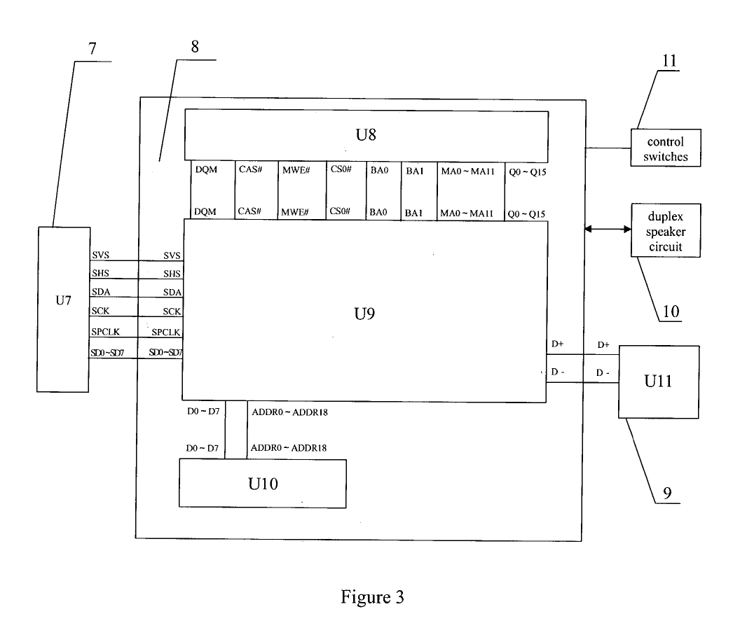

Referring to FIG. 3, slave central processing circuit 8 is composed of slave memory U8, slave primary processor chip U9 and slave ROM U10, wherein: The slave video acquisition circuit 7 converts the acquired analog video signals to 8-bit digital video signals. 8-bit digital video signal bus SD0˜SD7 of U7, the video acquisition chip of video acquisition circuit, is connected with the signal bus SD0˜SD7 of U9, namely the slave primary processor chip of the slave central processing circuit; signal wires SDA and SCK of U7 are connected with those of U9 respectively; register of U7 is set through the I²C bus composed of SDA and SCK; the line field synchronization signal wire of U7, namely SHS and SVS, are connected with those of U9 respectively; clock wire S PCLK of U7 is connected with that of slave primary processor U9.

Data bus Q0˜Q15 of U9 are connected with those of slave memory U8 (Q0˜Q15), and address bus MA0˜MA11 of U9 are connected with those of U8 (Q0˜Q15); the control bus of slave primary processor chip U9, namely DQM, MWE#, CAS#, CS0, BA0 and BA1# are connected with those of slave memory U8 respectively; DRAM is employed in U8 as a buffer for digital video and audio data.

The data bus of U9, from D0 to D7, is connected with its counterpart of slave ROM U10 (D0˜D7), and their address buses, both from ADDR0 to ADDR18, are also connected together. The slave ROM U10 is used to store program codes as well as data.

Data wire D+ and D− of slave primary processor chip U9 are connected with their counterparts of slave wireless communication interface circuit 9 respectively.

Slave central processing circuit 8 has a control interface that connects control switches 11 or annunciating detectors with Boolean output. The control switches 11 may be manual switches and the detectors may be infrared detectors smoke detectors or any other annunciating detectors with Boolean signal outputs.

Slave central processing circuit 8 is connected with duplex speaker circuit 10.

Referring to FIG. 2, the host includes host wireless communication interface circuit 1, host central processing circuit 4, communication interface circuit 6, display output circuit 3, display device 12, memory circuit 2 and hard disk interface circuit 5. There is an internal antenna in host wireless communication interface circuit 1.

Host wireless communication interface circuit 1 is connected with host central processing circuit 4 while the output of the latter is connected with the input of display output circuit 3, whose output again is connected with display device 12; host central processing circuit 4 can decode and decrypt the compressed video signals received by host wireless communication interface circuit 1 and then display them directly on display device 12 through the display output circuit module 3. Host central processing circuit 4 has a communication interface through which it has a connection with communication interface circuit 6; there are also memory circuit 2 and hard disk interface circuit 5, both are connected with host central processing circuit 4.

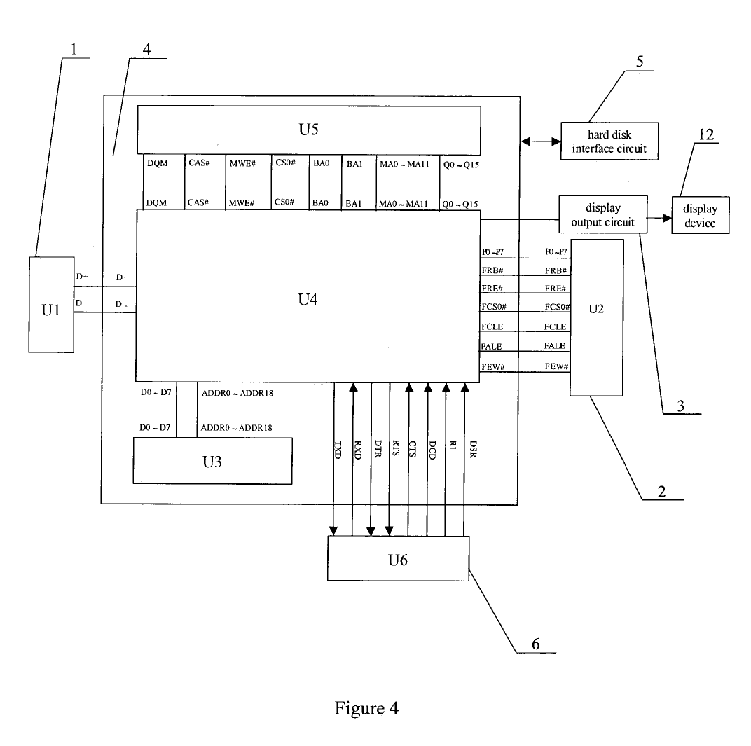

Referring to FIG. 4, host central processing circuit 4 includes host ROM U3, host primary processor chip U4 and host memory U5, wherein:

Data wires D+ and D−of host primary processor chip U4 are connected with those of host wireless communication interface circuit 1 respectively. Data bus of U4, the primary processor chip in the host central processing circuit, is connected with its counterpart of host memory U5, both from Q 0 to Q15. Host memory U5 employs dynamic RAM. Address bus of host primary processor chip U4, from MAO to MA11, is connected with that of memory U5, which is named from MA0 to MA11 too. The control wires of host primary processor chip U4, namely DQM, MWE#, CAS#, CS0#, BA0 and BA1#, are connected with their homonymous counterparts of host memory U5 respectively. Host memory U5 serves as a buffer for digital video and audio data.

Primary processor chip U4 in the host central processing circuit has its data bus D0˜D7 connected with that of host ROM U3, namely D0˜D7. Address bus ADDR0˜ADDR18 of U4 is connected with its homonymous counterpart of host ROM U3, which is used to store program codes as well as data.

Communication interface circuit 6 in the host is employed here to connect servers. It may be a MODEM interface circuit, a network interface circuit or a mobile data communication interface circuit. The interface of communication interface circuit 6 may be one of the following MODEM circuit: PSTN, GPRS or CDMA.

For the advantage of telephone wire interface in communication interface circuit 6, the host may create a direct connection with the server through the interface and PSTN. It can connect a server through PSTN and Internet as well.

Assume the communication interface circuit 6 of the host is implemented with the MODEM circuit U6, the primary processor chip U4 of host central processing circuit 4 communicates with Modem circuit U6. The ring indicator wire RI of primary processor chip U4 is connected with RI of U6 so that when a ring signal occurs, RI is driven active to inform primary processor chip U4 that there is a long distance page right now. Data carrier detection wire DCD of U4 is connected with that of U6, hence once U 6 detects communication link has been established, data can be transferred.

Data set ready wire DSR of U4 is connected with that of U6 to indicate that U6 is ready to receive data, but it doesn't mean a p2p connection has been established.

Clear to send wire CTS of U4 is connected that of U6 while request to send wire RTS of U4 is connected to that of U6. Such is the data terminal ready wire DTR. Data receive wire RXD of U4 is connected with that of U6 to receive serial data, and data transmit wire TXD of U4 is connected with that of U6 to transmit serial data.

The memory circuit 2 in the host works for the field storage of video and audio signals. It has a nonvolatile memory chip U2 inside, whose data bus, P0˜P7, is connected with that of primary processor chip U4 in the host central processing circuit 4. Also the control wires of memory chip U2 FRB#, FRE#, FCS0#, FCLE, FALE and FEW# are connected with those of primary processor chip U4 respectively, namely FRB#, FRE#, FCSO#, FCLE, FALE and FEW#. In this way access of compressed video and audio data is implemented. Primary processor chip U4 is connected with display output circuit 3 and display device 12 through signal wire CVBS.

The host central processing circuit 4 is connected with the hard disk interface circuit 5 in the host, which is used to connect hard disks to implement data access.

The method to implement real-time mobile detection of this invention can be divided into step I implemented by slave Z and step II by host M: The central processing circuit 8 in the slave Z serves for image compression coding, encryption and video mobile object detection. It can be implemented with an ASIC or an embedded processor, and step I is described as follows:

1) The video acquisition chip U7 in the slave converts the obtained analog video signals to digital video signals, which are transferred to the primary processor chip U9 of the slave central processing circuit 8. These digital video signals are processed by U9 with static or mobile image coding algorithm, encryption algorithm and video mobile object detection algorithm;

2) The process with video mobile object detection algorithm is that detecting mobile object from images according to the difference between the currently input image and that recorded previously;

3) Once the primary processor chip U9 of the slave gets object mobile detection signals and Boolean variable signals, it starts the slave central processing circuit 8 to perform image compression and transfers the compressed video and audio data to host M via the slave wireless communication interface circuit 9.

The central processing circuit 4 in host M is used for image compression coding. Both ASIC and embedded processor are available. Step 1I is described as follows:

1) Host wireless communication interface circuit 1 stores the received compressed video and audio data in memory circuit 2;

2) Primary processor chip U4 of the central processing circuit 4 in host M processes the received video and audio data with static/mobile image decoding algorithm; the received compressed video and audio signals are displayed directly on the display device 12 through display output circuit 3 after decryptions decompression and video coding process; they can also be saved in memory circuit 2 or stored in hard disks through hard disk interface circuit 5. These compressed video and audio data can be read from hard disks through hard disk interface circuit 5 or from memory circuit 2;

3) The communication interface circuit 6 is connected with host central processing circuit 4, which transmits the received compressed video signals to communication interface circuit 6; CIC 6 has a communication interface through which signals are sent to the server of the domestic safeguard system, and later transmitted to MMS mobile phones, e-mailbox or hand-held devices.

We claim:

1. A visual domestic safeguard system comprising a host M and several slaves Z, slave Z is mainly used to obtain video signals while the principal function of host M is to transmit signals to a server through communication networks, wherein:
I) Slave Z includes video acquisition circuit (7), slave central processing circuit (8), slave wireless communication interface circuit (9), duplex speaker circuit (10) and control switches (11); the output of video acquisition circuit (7) is connected with the input of slave central processing circuit (8), which is also connected with the slave wireless communication interface circuit (9); the duplex speaker circuit (10) is also connected with slave central processing circuit (8), and control switches (11) are connected in slave central processing circuit (8). Mobile detecting algorithm may be implemented in the slave central processing circuit (8) with software;
II) Host M consists of host wireless communication interface circuit (1), host central processing circuit (4), communication interface circuit (6), display output circuit (3), display device (12), memory circuit (2) and hard disk interface circuit (5); host wireless communication interface circuit (1) is connected with host central processing circuit (4) while the output of the latter is connected with the input of display output circuit (3), whose output again is connected with display device (12); host central processing circuit (4) can decode and decrypt the compressed video signals received by host wireless communication interface circuit (1) and then display them directly on the display device (12) through the display output circuit module (3). Host central processing circuit (4) has a communication interface through which it has a connection with communication interface circuit (6); there are also memory circuit (2) and hard disk interface circuit (5), both are connected with host central processing circuit (4);
III) Slave Z and Host M may establish a wireless interconnection in two ways: one is analog mode and the other is digital mode.

2. The visual domestic safeguard system according to claim 1, wherein slave Z and host M are interconnected in analog mode, and analog signals acquired, by the recorder are transmitted to host M through wireless communication interface.

3. The visual domestic safeguard system according to claim 1, wherein slave Z and host M are interconnected in digital mode, and slave Z converts the analog video signals to digital signals, which are transmitted to the host M through wireless communication interface after compression and encryption.

4. The visual domestic safeguard system according to claim 1, wherein the said slave central processing circuit (8) includes slave memory (U8), slave primary processor chip (U9) and slave Read Only Memory (U11).

5. The visual domestic safeguard system according to claim 1, wherein the said host central processing circuit (4) includes host Read Only Memory (U3), host primary processor chip (U4) and host memory (U5).

6. The visual domestic safeguard system according to claim 1, wherein communication interface circuit (6) of the host is employed to connect with a server; communication interface circuit (6) may be a MODEM interface circuit or a network interface circuit, it also may be a mobile data communication interface circuit; the interface of communication interface circuit (6) can be a MODEM circuit of PSTN, GPRS or CDMA.

7. A method for real-time monitoring and transmission of a visual domestic safeguard system, characterized in that the said system, a host-slave system interconnected in wireless communication mode, is divided into step I and step II implemented by slave Z and host M respectively.
Step I, which is implemented by slave Z, includes:
1) The video acquisition chip (U7) in the slave converts the obtained analog video signals to digital video signals, which are transferred to the primary processor chip (U9) of the central processing circuit (8) of the slave; primary processor chip (U9) then processes the digital video signals with static/mobile image coding algorithm, encryption algorithm and video mobile object detection algorithm;
2) The process with video mobile object detection algorithm is that detecting mobile objects from images according to the difference degree between currently input image and that recorded previously;
3) Once receive the object mobile detection signals and Boolean variable signals, primary processor chip (U9) of the slave triggers slave central processing circuit (8) to perform image compression and transmit the compressed video and audio data to host M through the slave wireless communication interface circuit (9).
Step II, which is implemented by host M, includes:
1) Host wireless communication interface circuit (1) stores the received compressed video and audio data in the memory circuit (2);
2) Primary processor chip (U4) of the host central processing circuit (4) processes the received video and audio data with static/mobile image decoding algorithm; the received compressed video and audio signals are displayed directly on the display device (12) through display output circuit (3) after decryption, decompression and video coding process; they can also be saved in memory circuit (2) or stored in hard disks through hard disk interface circuit (5); these compressed video and audio data can be read from hard disks through hard disk interface circuit (5) or from memory circuit (2);
3) Communication interface circuit (6) is connected with host central processing circuit (4), which transmits the received compressed video signals to communication interface circuit (6); communication interface circuit (6) has a communication interface through which signals are sent to the server of the domestic safeguard system, and later transmitted to MMS mobile phones e-mailbox or hand-held devices.
